(19) United States
(12) Patent Application Publication
(10) Pub. No.: US 2016/0267918 A1
(43) Pub. Date: Sep. 15, 2016

(54) TRANSMISSION DEVICE, VOICE RECOGNITION SYSTEM, TRANSMISSION METHOD, AND COMPUTER PROGRAM PRODUCT

(71) Applicant: KABUSHIKI KAISHA TOSHIBA, Tokyo (JP)

(72) Inventors: Kouji UENO, Mishima (JP); Shoko Miyamori, Kawasaki (JP); Mitsuyoshi Tachimori, Kawasaki (JP)

(73) Assignee: KABUSHIKI KAISHA TOSHIBA, Tokyo (JP)

(21) Appl. No.: 15/065,000

(22) Filed: Mar. 9, 2016

(30) Foreign Application Priority Data
Mar. 12, 2015 (JP) 2015-049866

(51) Int. Cl. G10L 19/24; G10L 17/00

(52) U.S. Cl. CPC G10L 19/24; G10L 17/00

(57) ABSTRACT

According to an embodiment, a transmission device includes an obtaining unit, first and second encoding units, a first determining unit, a first control unit, and a first transmitting unit. The obtaining unit obtains sound data. The first encoding unit encodes the sound data at a first bit rate. The second encoding unit encodes the sound data at a second bit rate lower than the first bit rate. The first determining unit determines whether a bandwidth of a network subjected to congestion control has exceeded the first bit rate. When the bandwidth of the network is determined to have exceeded the first bit rate, the first control unit switches an output destination of the obtained sound data from the second encoding unit to the first encoding unit. The first transmitting unit transmits the obtained sound data, that is encoded by the first encoding unit or the second encoding unit, to a voice recognition device via the network.

### CROSS-REFERENCE TO RELATED APPLICATIONS

This application is based upon and claims the benefit of priority from Japanese Patent Application No. 2015-049866, filed on Mar. 12, 2015; the entire contents of which are incorporated herein by reference.

### FIELD

Embodiments described herein relate generally to a transmission device, a voice recognition system, a transmission method, and a computer program product.

### BACKGROUND

A transmission device is known that transmits sound data, which is input from a microphone, to a voice recognition device via a network. In order to enable the voice recognition device to perform voice recognition in real time, a technology has been disclosed by which real-time transmission of sound data is achieved from the transmission device to the voice recognition device.

For example, in Japan Patent Application Laid-open No. 2003-195880, a technology is disclosed in which, using information regarding the bandwidth control performed during the transfer of initial utterance, the encoding bit rate of the second utterance onward is varied. According to this technology, the second utterance onward can be transferred in real time. In Japan Patent Application Laid-open No. 2002-290436, a technology is disclosed in which, according to the bandwidth and the congestion state of the network, the bit rate of the voice encoding method is switched from a high bit rate to a low bit rate.

### BRIEF DESCRIPTION OF THE DRAWINGS

FIG. 1 is a block diagram illustrating an example of a transmission device;

FIG. 2 is a diagram illustrating an example of a frame;

FIG. 3 is a flowchart for explaining an exemplary sequence of processes performed during a transmission process;

FIG. 4 is a block diagram illustrating an example of a transmission device;

FIG. 5 is a flowchart for explaining an exemplary sequence of processes performed during a transmission process;

FIG. 6 is a block diagram illustrating an example of a transmission device;

FIG. 7 is a block diagram illustrating an example of a voice recognition system;

FIG. 8 is a diagram illustrating an exemplary data structure of sound data;

FIG. 9 is a diagram illustrating an example of a frame;

FIG. 10 is a flowchart for explaining a sequence of processes performed during an interrupt process;

FIG. 11 is a flowchart for explaining a sequence of processes performed during a voice recognition process; and

FIG. 12 is block diagram illustrating an exemplary hardware configuration.

### DETAILED DESCRIPTION

According to an embodiment, a transmission device includes an obtaining unit, a first encoding unit, a second encoding unit, a first determining unit, a first control unit, and a first transmitting unit. The obtaining unit obtains sound data. The first encoding unit encodes the sound data at a first bit rate. The second encoding unit encodes the sound data at a second bit rate which is lower than the first bit rate. The first determining unit determines whether a bandwidth of a network, which is subjected to congestion control, has exceeded the first bit rate. When the bandwidth of the network is determined to have exceeded the first bit rate, the first control unit switches an output destination of the obtained sound data from the second encoding unit to the first encoding unit. The first transmitting unit transmits the obtained sound data, that is encoded by the first encoding unit or the second encoding unit, to a voice recognition device via the network.

Embodiments are described below in detail with reference to the accompanying drawings.

### First Embodiment

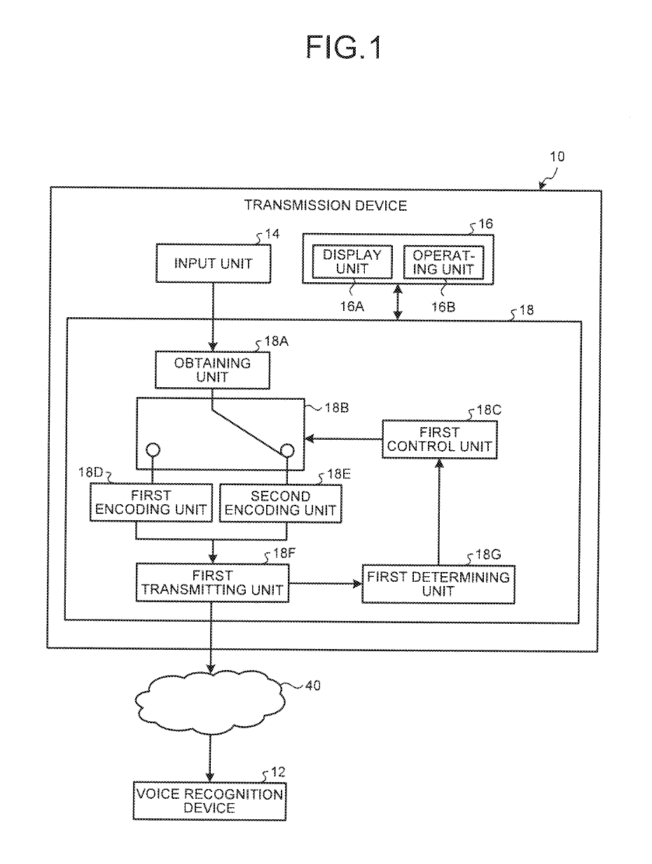

FIG. 1 is a block diagram illustrating an example of a transmission device 10 according to a first embodiment.

The transmission device 10 is connected to a voice recognition device 12 via a network 40. Herein, the network 40 is subjected to congestion control. Moreover, the network 40 uses a communication protocol that includes a congestion control algorithm. Examples of the communication protocol include the transmission control protocol (TCP).

The transmission device 10 transmits encoded sound data to the voice recognition device 12 via the network 40. The voice recognition device 12 decodes the received sound data and performs recognition of the voice included in the sound data (i.e., performs voice recognition). Herein, the voice recognition device 12 can be a known device performing voice recognition.

The transmission device includes an input unit 14, a user interface (UI) unit 16, and a control unit 18. Herein, the control unit 18 is connected with the input unit 14 and the UI unit 16 in a manner enabling communication of data and signals.

The input unit 14 receives sound from outside and converts the sound into sound data, and outputs the sound data to the control unit 18. Examples of the input unit 14 include a microphone.

In the first embodiment, the explanation is given under the assumption that the transmission device 10 is a mobile terminal. In this case, the input unit 14 can be an auxiliary microphone of the transmission device 10 which is a mobile terminal. However, the input unit 14 is not limited to a microphone, and can alternatively be a hardware component or software having the function of converting the received sound into sound data.

In the first embodiment, a sound includes a voice. Thus, the input unit outputs the sound data, which contains voice data, to the control unit 18.

The UI unit 16 includes a display unit 16A and an operating unit 16B. The display unit 16A is a device for displaying various images. Herein, the display unit 16A is a known display device such as a liquid crystal display (LCD) or an organic electroluminescence (EL) device.

The operating unit 16B receives various operations from the user. Herein, for example, the operating unit 16B is a combination of one or more of a mouse, buttons, a remote controller, and a keyboard. The operating unit 16B receives various operations from the user, and outputs instruction signals according to the received various operations to the control unit 18.

Meanwhile, the display unit 16A and the operating unit 16B can be configured in an integrated manner. More particularly, the display unit 16A and the operating unit 16B can be configured as the UI unit 16 having the operation receiving function as well as the display function. Examples of the UI unit 16 include a liquid crystal display (LCD) equipped with a touch-sensitive panel.

The control unit 18 is a computer including a central processing unit (CPU), and controls the entire transmission device 10. However, the control unit 18 is not limited to include a CPU, and can alternatively be configured with circuitry.

The control unit 18 includes an obtaining unit 18A, a first switching unit 18B, a first control unit 18C, a first encoding unit 18D, a second encoding unit 18E, a first transmitting unit 18F, and a first determining unit 18G. Some or all of the obtaining unit 18A, the first switching unit 18B, the first control unit 18C, the first encoding unit 18D, the second encoding unit 18E, the first transmitting unit 18F, and the first determining unit 18G can be implemented by making a processor such as a CPU to execute computer programs, that is, can be implemented using software; or can be implemented using hardware such as an integrated circuit (IC); or can be implemented using a combination of software and hardware.

The obtaining unit 18A obtains sound data from the input unit 14. That is, when a sound is input thereto, the input unit 14 sequentially outputs sound data of the sound to the obtaining unit 18A. Thus, the obtaining unit 18A obtains the sound data from the input unit 14.

The first encoding unit 18D is capable of encoding the sound data at a first bit rate. The first bit rate can be a value equal to or greater than the bit rate at which voice recognition can be performed with accuracy in the voice recognition device 12 which is a transmission destination of the encoded sound data. For that reason, the first bit rate can be set in advance according to the voice recognition capability of the voice recognition device 12 whish is the transmission destination.

The first encoding unit 18D encodes the sound data using a known encoding algorithm. More particularly, the first encoding unit 18D encodes the sound data into a format that can be subjected to high-accuracy voice recognition in the voice recognition device 12.

For example, the first encoding unit 18D encodes the sound data using a lossless compression algorithm or a low-compressive lossy compression algorithm. Examples of the lossless compression algorithm include the free lossless audio codec (FLAC). However, that is not the only possible example. Meanwhile, alternatively, the first encoding unit 18D can output the sound data as it is without compression (without encoding) as the encoded sound data.

Still alternatively, the first encoding unit 18D can encode all feature quantities included in the sound data. In the first embodiment, each feature quantity represents a feature quantity used in voice recognition in the voice recognition device 12. More particularly, the feature quantities represent the Mel-frequency cepstral coefficient (MFCC).

In the first embodiment, as an example, the explanation is given for an example in which the first bit rate is 256 kbps. However, the first bit rate is not limited to this value.

The second encoding unit 18E is capable of encoding the sound data at a second bit rate that is lower than the first bit rate.

As long as the second bit rate has a lower value than the first bit rate, it serves the purpose. Moreover, it is desirable that the second bit rate is equal to or smaller than the window size in the slow start stage of the TCP. That is, even in the state in which congestion control such as the slow start is applied, the second encoding unit 18E encodes the sound data at a bit rate that enables real-time transfer to the voice recognition device 12.

For example, the second encoding unit 18E encodes the sound data at the second bit rate using, for example, the Speex algorithm.

Alternatively, the second encoding unit 18E can encode the sound data into some of the feature quantities that are required in voice recognition in the voice recognition device 12. Since the explanation of the feature quantities is given earlier, it is not repeated.

The second bit rate either can be a fixed value or can be variable in nature. When the second bit rate is variable in nature, the second encoding unit 18E can perform encoding in according to the variable bit rate format. In that case, during the period of time until the bandwidth of the network 40 exceeds the first bit rate, the second bit rate can be increased in a continuous manner or in a stepwise manner.

In the first embodiment, as an example, the explanation is given for a case in which the second bit rate is 8 kbps. However, the second bit rate is not limited to be 8 kbps.

The first transmitting unit 18F transmits the sound data, which has been encoded by the first encoding unit 18D or the second encoding unit 18E, to the voice recognition device 12 via the network 40. Herein, the first transmitting unit 18F transmits the encoded sound data in appropriate transfer units to the voice recognition device 12. The transfer units are sometimes called frames.

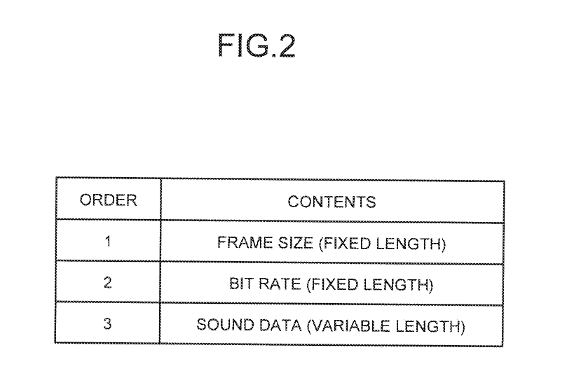

FIG. 2 is a diagram illustrating an example of a frame. For example, as illustrated in FIG. 2, a frame includes a value indicating the frame size, a value indicating the bit rate, and sound data. The value indicating the frame size is expressed as a fixed length. The value indicating the bit rate is also expressed as a fixed length. The sound data is of a variable length. The value of the bit rate included in a frame represents the value of the bit rate after the corresponding sound data has been encoded.

Returning to the explanation with reference to FIG. 1, the first determining unit 18G determines whether the bandwidth of the network 40 has exceeded the first bit rate. That is, the first determining unit 18G determines whether the existing bandwidth of the network 40 has exceeded the first bit rate.

For example, the first determining unit 18G determines whether the volume of transmission data that is transmitted per unit of time (one second) by the first transmitting unit 18F to the voice recognition device 12 has exceeded the first bit rate. With this determination, the first determining unit 18G determines whether the existing bandwidth of the network 40 has exceeded the first bit rate.

In the first embodiment, as an example, assume that the first bit rate is 256 kbps. Thus, the first determining unit 18G determines whether the existing volume of transmission data per unit of time has exceeded 256 kbps, to thereby determine whether the bandwidth of the network 40 has exceeded the first bit rate.

Meanwhile, the first determining unit 18G can implement some other method too for determining whether the bandwidth of the network 40 has exceeded the first bit rate.

For example, the first determining unit 180 obtains the existing bandwidth of the network 40 from the network communication performed by the first transmitting unit 18F. Then, the first determining unit 180 can determine whether the existing bandwidth of the network 40 has exceeded the first bit rate. Meanwhile, in the TCP, the existing bandwidth of the network 40 can be calculated from the existing window size and the round-trip delay time (round trip time: RTT) using a known method.

The first switching unit 18B is a switch for switching the output destination for the obtaining unit 18A between the first encoding unit 18D and the second encoding unit 18E. The first switching unit 18B is controlled by the first control unit 18C.

When the bandwidth of the network 40 is determined to have exceeded the first bit rate, the first control unit 18C switches the output destination of the obtained sound data from the second encoding unit 18E to the first encoding unit 18D.

More particularly, in the initial state, the first control unit 18C controls the first switching unit 18B to switch the output destination of the sound data, which is obtained by the obtaining unit 18A, to the second encoding unit 18E. Herein, the initial state represents the state attained immediately after an application for performing the transmission of the encoded data is activated in the control unit 18.

For that reason, after the activation, during the period of time until the first determining unit 18G determines that the bandwidth of the network 40 has exceeded the first bit rate (hereinafter, called a first time period), the first switching unit 18B keeps the output destination for the obtaining unit 18A switched to the second encoding unit 18E. That is, during the first time period, the first transmitting unit 18F transmits the encoded sound data, which is obtained by means of encoding by the second encoding unit 18E, to the voice recognition device 12 via the network 40.

When the bandwidth of the network 40 is determined to have exceeded the first bit rate, the first control unit 18C switches the output destination of the obtained sound data from the second encoding unit 18E to the first encoding unit 18D. Hence, after the bandwidth of the network 40 exceeds the first bit rate, the first transmitting unit 18F transmits the encoded sound data, which is obtained by means of encoding by the first encoding unit 18D, to the voice recognition device 12 via the network 40.

Meanwhile, after the output destination of the sound data, which is obtained by the obtaining unit 18A, is switched from the second encoding unit 18E to the first encoding unit 18D; the bandwidth of the network 40 may sometimes be determined to be equal to or lower than the first bit rate. In such a case too, it is desirable that the first control unit 18C keeps the output destination for the obtaining unit 18A switched to the first encoding unit 18D.

That is, regarding the output destination of the sound data obtained during the first time period starting from the activation of the transmission device 10 until the bandwidth of the network 40 is determined to have exceeded the first bit rate, the first control unit 18C keeps the output destination switched to the second encoding unit 18E. Then, regarding the output destination of the sound data obtained in a second time period starting after it is determined that the bandwidth of the network 40 has exceeded the first bit rate, the first control unit 18C keeps the output destination switched to the first encoding unit 18D.

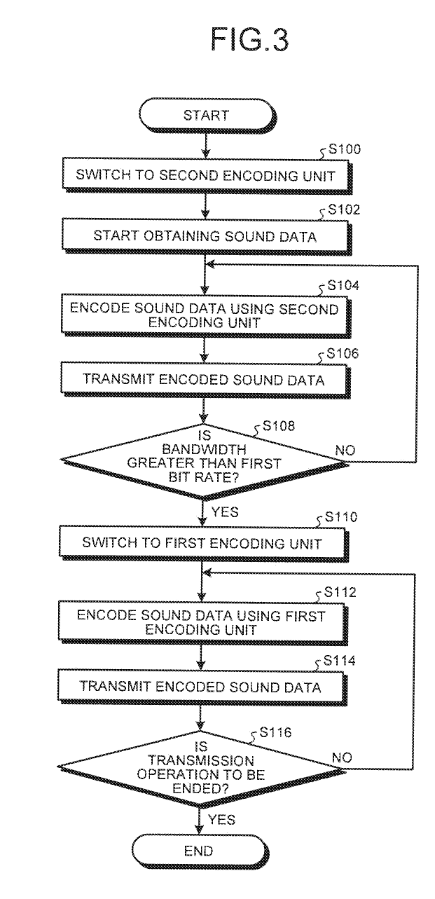

Given below is the explanation of a sequence of processes during the transmission process performed by the transmission device 10. FIG. 3 is a flowchart for explaining an exemplary sequence of processes during the transmission process performed by the transmission device 10.

Firstly, as a result of a user operation performed using the UI unit 16, an instruction is issued to execute a transmission program for performing the transmission of sound data. The CPU reads and executes a computer program for performing the transmission process from a memory medium; so that the obtaining unit 18A, the first switching unit 18B, the first control unit 18C, the first encoding unit 18D, the second encoding unit 18E, the first transmitting unit 18F, and the first determining unit 18G are loaded in a main memory device.

Firstly, the first control unit 18C switches the output destination for the obtaining unit 18A to the second encoding unit 18E (Step S100). Meanwhile, at the time of activation, if the output destination for the obtaining unit 18A is already switched to the second encoding unit 18E, the process at Step S100 can be skipped.

Then, the obtaining unit 18A starts obtaining the sound data from the input unit 14 (Step S102). More particularly, the input unit 14 outputs the received sound data to the obtaining unit 18A. Thus, the obtaining unit 18A obtains the sound data from the input unit 14. In the process performed at Step S100, the output destination for the obtaining unit 18A has been switched to the second encoding unit 18E. For that reason, the obtaining unit 18A outputs the obtained sound data to the second encoding unit 18E.

Subsequently, the second encoding unit 18E encodes the sound data obtained from the obtaining unit 18A (Step S104). Then, the first transmitting unit 18F transmits the encoded sound data, which is obtained by means of encoding by the second encoding unit 18E, to the voice recognition device 12 via the network 40 (Step S106).

Subsequently, the first determining unit 18G determines whether the bandwidth of the network 40 has exceeded the first bit rate (Step S108). If the bandwidth is equal to or lower than the first bit rate (No at Step S108), then the system control returns to Step S104.

On the other hand, if the first determining unit 18G determines that the bandwidth of the network 40 has exceeded the first bit rate (Yes at Step S108), then the system control proceeds to Step S110.

At Step S110, the first control unit 18C switches the output destination of the sound data, which is obtained by the obtaining unit 18A, from the second encoding unit 18E to the first encoding unit 18D (Step S110). As a result of the process performed at Step S110, the output destination for the obtaining unit 18A is switched to the first encoding unit 18D. Hence, after Step S110, the obtaining unit 18A outputs the sound data to the first encoding unit 18D.

The first encoding unit 18D encodes the sound data obtained from the obtaining unit 18A (Step S112). The first transmitting unit 18F transmits the encoded sound data, which is obtained by means of encoding by the first encoding unit 18D, to the voice recognition device 12 via the network 40 (Step S114).

Then, the control unit 18 determines whether to end the transmission process (Step S116). For example, the control unit 18 determines whether an end signal indicating the end of the transmission process is received via the UI unit 16, and performs the determination at Step S116. When an operation instruction indicating the end of the transmission process is received by UI unit 16 from the user, the UI unit 16 can output an end signal to the control unit 18.

If the control unit 18 determines not to end the transmission process (No at Step S116), then the system control returns to Step S112. However, if the control unit 18 determines to end the transmission process (Yes at Step S116), the present routine is ended.

As explained above, the transmission device 10 according to the first embodiment includes the obtaining unit 18A, the first encoding unit 18D, the second encoding unit 18E, the first transmitting unit 18F, the first determining unit 18G, and the first control unit 18C.

The obtaining unit 18A obtains sound data. The first encoding unit 18D is capable of encoding the sound data at the first bit rate. The second encoding unit 18E is capable of encoding the sound data at the second bit rate that is lower than the first bit rate. The first determining unit 18G determines whether the bandwidth of the network 40, which is subjected to congestion control, has exceeded the first bit rate. When the bandwidth of the network 40 is determined to have exceeded the first bit rate, the first control unit 18C switches the output destination of the obtained sound data from the second encoding unit 18E to the first encoding unit 18D. Then, the first transmitting unit 18F transmits the sound data, which has been encoded by the first encoding unit 18D or the second encoding unit 18E, to the voice recognition device 12 via the network 40.

In this way, in the first embodiment, the transmission device 10 transmits, to the voice recognition device 12 via the network 40, the encoded sound data obtained by means of encoding by the second encoding unit 18E which is capable of encoding data at the second bit rate that is lower than the encoding bit rate of the first encoding unit 18D. Then, if the bandwidth of the network 40 is determined to have exceeded the first bit rate, the transmission device 10 transmits, to the voice recognition device 12 via the network 40, the encoded sound data obtained by means of encoding by the first encoding unit 18D capable of encoding data at the first bit rate that is higher than the encoding bit rate of the second encoding unit 18E.

For that reason, even in the case in which the sound data obtained by the obtaining unit 18A does not contain voice data of a voice, the transmission of the encoded sound data to the voice recognition device 12 is started.

Consider a case in which the transmission program in the control unit 18 is run in response to an operation instruction issued by the user from the UI unit 16, and the user utters “yes”. In this case, for example, as a result of executing the transmission program, the control unit 18 displays a question such as “May we proceed?” on the UI unit 16. Consider a case in which the user utters “yes” as the answer to the question.

In this case, even if the user is yet to utter “yes”, the transmission device 10 transmits the encoded sound data, which is obtained by means of encoding by the second encoding unit 18E, to the voice recognition device 12 via the network 40. That is, without waiting for the utterance by the user, the transmission device 10 starts transmitting the encoded sound data to the voice recognition device 12.

When the bandwidth of the network 40 exceeds the first bit rate, the transmission device 10 transmits the encoded sound data, which is obtained by means of encoding by the first encoding unit 18D capable of encoding data at the first bit rate, to the voice recognition device 12 via the network 40.

Hence, in the transmission device 10 according to the first embodiment, during the period of time until the voice of the user is input to the input unit 14, the bandwidth of the network 40 can be set to be equal to or greater than the bit rate required by the voice recognition device 12 to perform high-accuracy voice recognition (i.e., equal to or greater than the first bit rate).

Thus, in the transmission device 10 according to the first embodiment, after the transmission program is run in the transmission device 10, the sound data that contains the initially-uttered voice of the user and that is subjectable to high-accuracy voice recognition can be transmitted in real time to the voice recognition device 12.

Therefore, the transmission device 10 according to the first embodiment can transmit the sound data subjectable to high-accuracy voice recognition to the voice recognition device 12 in real time.

Meanwhile, in the first embodiment, real-time transmission implies that the data rate of the sound data to be transmitted is lower than the bandwidth of the network 40.

More particularly, when the sound data is transmitted at a data rate exceeding the bandwidth of the network 40, the portion of the sound data after the exceedance of bandwidth gets accumulated in a buffer in the transmission device 10. For example, when the network 40 has a bandwidth of 64 kbps and when sound data of 128 kbps is transmitted, the data worth 64 kilobits representing the difference gets accumulated in the buffer every second. In such a state, the delay goes on increasing over time. If this state continues for 10 seconds, then the data worth 640 kilobits gets accumulated in the buffer. It implies a delay of five seconds (640/128=5 (seconds)). In contrast, when real-time transmission is performed, voice recognition can be done in real time in the voice recognition device 12.

### Second Embodiment

In a second embodiment, the explanation is given for a configuration including a second determining unit that determines the start of a voice section from sound data.

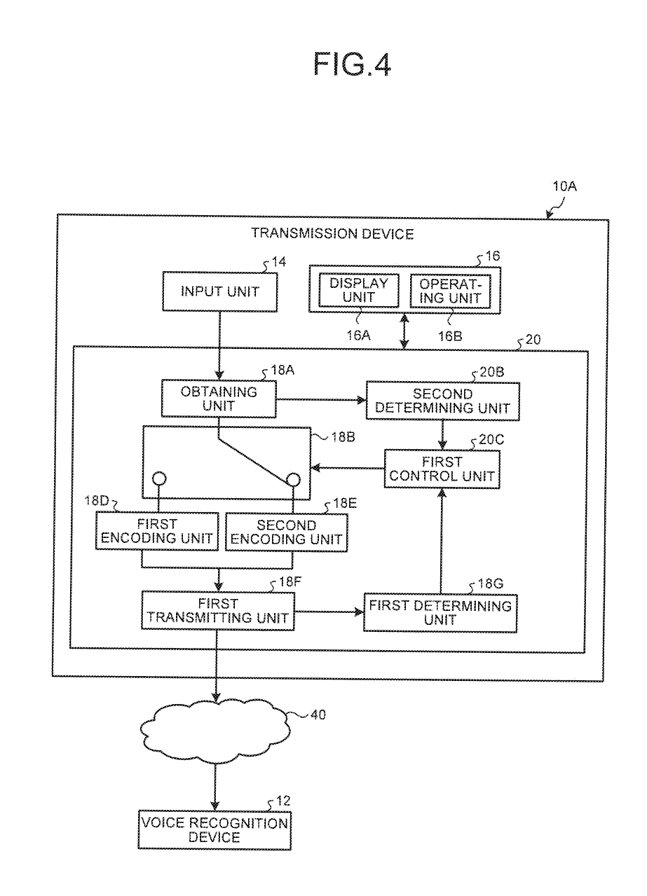

FIG. 4 is a block diagram illustrating an example of a transmission device 10A according to the second embodiment.

The transmission device 10A is connected to the voice recognition device 12 via the network 40. Herein, the voice recognition device 12 and the network 40 are identical to the first embodiment.

The transmission device 10A transmits encoded sound data to the voice recognition device 12 via the network 40. The transmission device 10A includes the input unit 14, the UI unit 16, and a control unit 20. Herein, the control unit 20 is connected with the input unit 14 and the UI unit 16 in a manner enabling communication of data and signals. The input unit 14 and the UI unit 16 are identical to the first embodiment.

The control unit 20 is a computer including a CPU, and controls the entire transmission device 10A. However, the control unit 20 is not limited to include a CPU, and can alternatively be configured with circuitry.

The control unit 20 includes the obtaining unit 18A, the first switching unit 18B, a second determining unit 20B, a first control unit 20C, the first encoding unit 18D, the second encoding unit 18E, the first transmitting unit 18F, and the first determining unit 18G. Some or all of the obtaining unit 18A, the first switching unit 18B, the second determining unit 20B, the first control unit 20C, the first encoding unit 18D, the second encoding unit 18E, the first transmitting unit 18F, and the first determining unit 18G can be implemented by making a processor such as a CPU to execute computer programs, that is, can be implemented using software; or can be implemented using hardware such as an integrated circuit (IC); or can be implemented using a combination of software and hardware.

The obtaining unit 18A, the first switching unit 18B, the first encoding unit 18D, the second encoding unit 18E, the first transmitting unit 18F, and the first determining unit 18G are identical to the first embodiment.

The second determining unit 20B determines the start of a voice section from the sound data obtained from the obtaining unit 18A. Herein, the second determining unit 20B can implement a known method to determine the start of a voice section included in the sound data. It is desirable that, from among various methods known for determining the start of a voice section, a method having a relatively low processing load is implemented.

For example, the second determining unit 20B implements a method in which the power of input signals is compared with a threshold value, and the start of a voice section is detected. More specifically, the second determining unit 20B treats the value of the voice of a user as sound pressure and considers the start of a voice section when the sound pressure equal to or greater than a predetermined pressure is input to the input unit 14. For example, the predetermined pressure can be set as the sound pressure at the time when the user utters something at the normal volume while keeping the mouth close to the input unit 14 of the transmission device 10A.

In the second embodiment, the first control unit 20C is used in place of the first control unit 18C according to the first embodiment. Thus, the first control unit 20C controls the switching performed by the first switching unit 18B.

More particularly, when the bandwidth of the network 40 is determined to have exceeded the first bit rate or when a voice section is determined to have started; the first control unit 20C switches the output destination of the sound data, which is obtained by the obtaining unit 18A, from the second encoding unit 18E to the first encoding unit 18D.

More particularly, in the initial state, the first control unit 20C controls the first switching unit 18B to switch the output destination of the sound data, which is obtained by the obtaining unit 18A, to the second encoding unit 18E. Herein, the definition of the initial state is identical to the first embodiment.

For that reason, after the activation, during the period of time until the first determining unit 18G determines that the bandwidth of the network 40 has exceeded the first bit rate or until the second determining unit 20B determines that a voice section has started (hereinafter, called a second time period), the first switching unit 18B keeps the output destination for the obtaining unit 18A switched to the second encoding unit 18E. That is, during the second time period, the first transmitting unit 18F transmits the encoded sound data, which is obtained by means of encoding by the second encoding unit 18E, to the voice recognition device 12 via the network 40.

When the bandwidth of the network 40 is determined to have exceeded the first bit rate or when a voice section is determined to have started, the first control unit 20C switches the output destination of the obtained sound data from the second encoding unit 18E to the first encoding unit 18D.

Hence, after the bandwidth of the network 40 exceeds the first bit rate or after the start of a voice section is determined from the sound data obtained by the obtaining unit 18A, the first transmitting unit 18F transmits the encoded sound data, which is obtained by means of encoding by the first encoding unit 18D, to the voice recognition device 12 via the network 40.

Meanwhile, after the output destination of the sound data, which is obtained by the obtaining unit 18A, is switched from the second encoding unit 18E to the first encoding unit 18D, the bandwidth of the network 40 may sometimes be determined to be equal to or lower than the first bit rate. In such a case too, it is desirable that the first control unit 20C keeps the output destination for the obtaining unit 18A switched to the first encoding unit 18D.

Moreover, after the output destination of the sound data, which is obtained by the obtaining unit 18A, is switched from the second encoding unit 18E to the first encoding unit 18D; there are times when the voice section is determined to have ended or there are times when a new voice section is determined to have started. In such a case too, it is desirable that the first control unit 20C keeps the output destination for the obtaining unit 18A switched to the first encoding unit 18D.

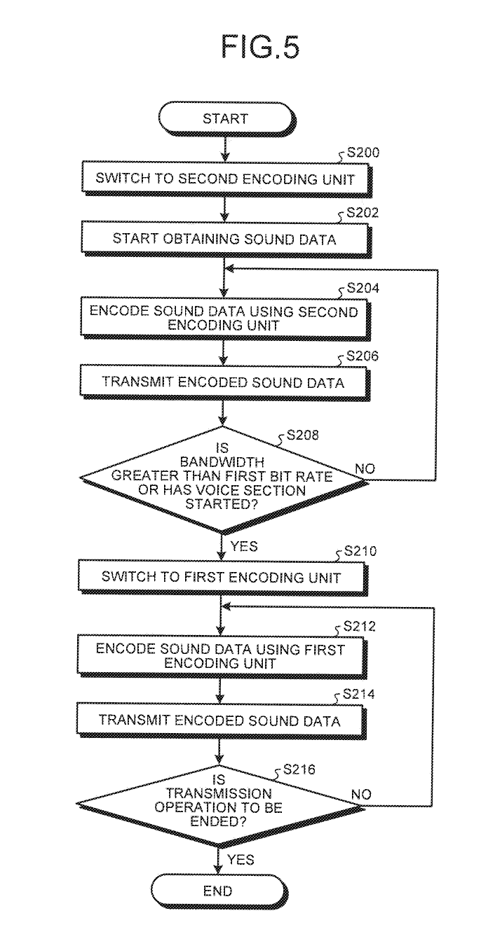

Given below is the explanation of a sequence of processes during the transmission process performed by the transmission device 10A. FIG. 5 is a flowchart for explaining an exemplary sequence of processes during the transmission process performed by the transmission device 10A.

Firstly, as a result of a user operation of the UI unit 16, an instruction is issued to execute a transmission program for performing the transmission of sound data. The CPU reads and executes a computer program for performing the transmission process from a memory medium; so that the obtaining unit 18A, the first switching unit 18B, the first encoding unit 18D, the second encoding unit 18E, the first transmitting unit 18F, the first determining unit 18G, the first control unit 18C, the second determining unit 20B, and the first control unit 20C are loaded in a main memory device.

Firstly, the first control unit 20C switches the output destination for the obtaining unit 18A to the second encoding unit 18E (Step S200). Meanwhile, at the time of activation, if the output destination for the obtaining unit 18A is already switched to the second encoding unit 18E, the process at Step S200 can be skipped.

Then, the obtaining unit 18A starts obtaining the sound data from the input unit 14 (Step S202). In the process performed at Step S200, the output destination for the obtaining unit 18A is switched to the second encoding unit 18E. For that reason, the obtaining unit 18A outputs the obtained sound data to the second encoding unit 18E.

Subsequently, the second encoding unit 18E encodes the sound data obtained from the obtaining unit 18A (Step S204). Then, the first transmitting unit 18F transmits the encoded sound data, which is obtained by means of encoding by the second encoding unit 18E, to the voice recognition device 12 via the network 40 (Step S206).

Subsequently, the first determining unit 18G determines whether the bandwidth of the network 40 has exceeded the first bit rate, and the second determining unit 20B determines whether a voice section has started (Step S208).

If the bandwidth is equal to or lower than the first bit rate and if no voice section is determined to have started (No at Step S208), then the system control returns to Step S204.

On the other hand, if the bandwidth of the network 40 has exceeded the first bit rate or if a voice section is determined to have started (Yes at Step S208), then the system control proceeds to Step S210.

At Step S210, the first control unit 20C switches the output destination of the sound data, which is obtained by the obtaining unit 18A, from the second encoding unit 18E to the first encoding unit 18D (Step S210). As a result of the process performed at Step S210, the output destination for the obtaining unit 18A is switched to the first encoding unit 18D. Hence, after Step S210, the obtaining unit 18A outputs the sound data to the first encoding unit 18D.

The first encoding unit 18D encodes the sound data obtained from the obtaining unit 18A (Step S212). The first transmitting unit 18F transmits the encoded sound data, which is obtained by means of encoding by the first encoding unit 18D, to the voice recognition device 12 via the network 40 (Step S214).

Then, the control unit 20 determines whether to end the transmission process (Step S216). The determination at Step S216 can be performed in an identical manner to the determination performed at S116 according to the first embodiment.

If the control unit 20 determines not to end the transmission process (No at Step S216), then the system control returns to Step S212. However, if the control unit 20 determines to end the transmission process (Yes at Step S216), the present routine is ended.

As described above, the transmission device 10A according to the second embodiment includes the obtaining unit 18A, the first switching unit 18B, the first encoding unit 18D, the second encoding unit 18E, the first transmitting unit 18F, the first determining unit 18G, the first control unit 20C, and the second determining unit 20B.

The second determining unit 20B determines the start of a voice section from the sound data obtained from the obtaining unit 18A. When the bandwidth of the network 40 is determined to have exceeded the first bit rate or when a voice section is determined to have started, the first control unit 20C switches the output destination of the obtained sound data from the second encoding unit 18E to the first encoding unit 18D.

In this way, in the transmission device 10A according to the second embodiment, when the bandwidth of the network 40 is determined to have exceeded the first bit rate or when a voice section is determined to have started, the output destination of the obtained voice data is switched from the second encoding unit 18E to the first encoding unit 18D.

In this way, in the transmission device 10A according to the second embodiment, even in the case in which the bandwidth of the network 40 is equal to or lower than the first bit rate, if a voice section is determined to have started, the first encoding unit 18D encodes the sound data. Moreover, in the transmission device 10A, the sound data encoded by the first encoding unit 18D is transmitted to the voice recognition device 12 via the network 40.

For that reason, in the transmission device 10A according to the second embodiment, even if the user starts uttering before the bandwidth of the network 40 reaches the first bit rate, sound data containing voice data of the utterance can be transmitted to the voice recognition device 12 in a format subjectable to high-accuracy voice recognition. Moreover, in the transmission device 10A according to the second embodiment, as compared to a case in which network transfer is started in a simultaneous manner to the utterance by the user, the bandwidth of the network 40 is expanded. That enables achieving prevention of the delay in transmission to the voice recognition device 12.

Thus, in the transmission device 10A according to the second embodiment, in addition to achieving the effect achieved by the transmission device 10 according to the first embodiment, sound data containing the voice data of the initial utterance of the user after execution of the transmission program can also be transmitted to the voice recognition device 12 in a format subjectable to high-accuracy voice recognition. Hence, the transmission device 10A according to the second embodiment can transmit, to the voice recognition device 12, sound data subjectable to voice recognition with higher accuracy.

### Third Embodiment

In a third embodiment, the explanation is given for a configuration that further includes a second control unit.

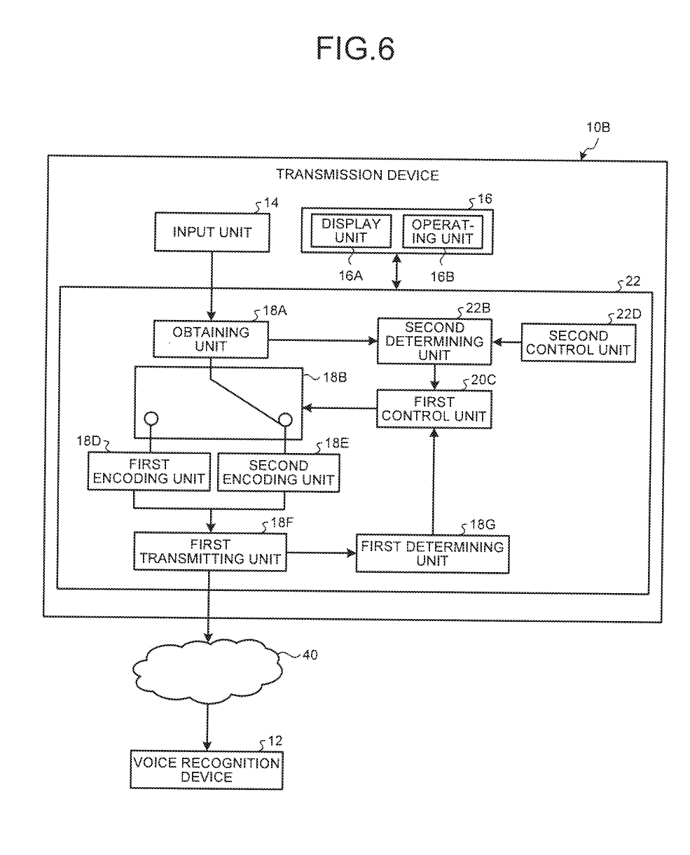

FIG. 6 is a block diagram illustrating an example of a transmission device 10B according to the third embodiment.

The transmission device 10B is connected to the voice recognition device 12 via the network 40. Herein, the voice recognition device 12 and the network 40 are identical to the first embodiment.

The transmission device 10B transmits encoded sound data to the voice recognition device 12 via the network 40. The transmission device 10B includes the input unit 14, the UI unit 16, and a control unit 22. Herein, the control unit 22 is connected with the input unit 14 and the UI unit 16 in a manner enabling communication of data and signals. The input unit 14 and the UI unit 16 are identical to the first embodiment.

The control unit 22 is a computer including a CPU, and controls the entire transmission device 10B. However, the control unit 22 is not limited to include a CPU, and can alternatively be configured with circuitry.

The control unit 22 includes the obtaining unit 18A, the first switching unit 18B, a second determining unit 22B, the first control unit 20C, the first encoding unit 18D, the second encoding unit 18E, the first transmitting unit 18F, the first determining unit 18G, and a second control unit 22D. Some or all of the obtaining unit 18A, the first switching unit 18B, the second determining unit 22B, the first control unit 20C, the first encoding unit 18D, the second encoding unit 18E, the first transmitting unit 18F, the first determining unit 18G, and the second control unit 22D can be implemented by making a processor such as a CPU to execute computer programs, that is, can be implemented using software; or can be implemented using hardware such as an integrated circuit (IC); or can be implemented using a combination of software and hardware.

The obtaining unit 18A, the first switching unit 18B, the first encoding unit 18D, the second encoding unit 18E, the first transmitting unit 18F, and the first determining unit 18G are identical to the first embodiment. The first control unit 20C is identical to the second embodiment.

In an identical manner to the second determining unit 20B according to the second embodiment, the second determining unit 22B determines the start of a voice section from the sound data obtained from the obtaining unit 18A.

In the third embodiment, the second determining unit 22B is controlled by the second control unit 22D. The second control unit 22D estimates the period of time for which a voice is input to the input unit 14 (hereinafter, called a third time period) and controls the second determining unit 22B to determine the start of a voice section from the sound data obtained during the third time period.

For example, once the transmission program is started, the control unit 22 displays an interactive character image on the UI unit 16. For example, the control unit 22 displays a character image “May we proceed?” on the UI unit 16. Moreover, the control unit 22 can also output a sound “May be proceed?” from a speaker (not illustrated). In response to the question, the user utters “yes”, for example. Then, the input unit 14 outputs sound data indicating “yes” uttered by the user to the obtaining unit 18A.

In this case, the second control unit 22D sets the start time to the point of time after the display of the character image representing the question or after the output of a sound representing the question, and estimates the period of time from the start time up to the end of the voice uttered by the user in response as the third time period for which a voice is input to the input unit 14. The length of the third time period starting from the start time up to the end of the voice can be estimated as follows. For example, the second control unit 22D can provide a plurality of types of response patterns corresponding to the question and, as the third time period, can estimate the period of time of the voice of the longest response pattern (i.e., the pattern having the longest period of utterance) from among the plurality of types of response patterns corresponding to the question.

Then, the second control unit 22D controls the second determining unit 20B to determine the start of a voice section from the sound data obtained during the third time period having the abovementioned length starting from the estimated start time.

Meanwhile, the sequence of processes during the transmission process performed by the transmission device 10B is identical to the sequence of processes followed according to the second embodiment, except for the fact that the determination of the start of a voice section as performed by the second determining unit 22B (the second determining unit 20B) is limited within the third time period controlled by the second control unit 22D.

As described above, the transmission device 10B according to the third embodiment includes the second control unit 22D in addition to the configuration according to the second embodiment. The second determining unit 22B is controlled by the second control unit 22D. Moreover, the second control unit 22D estimates the third time period for which a voice is input, and controls the second determining unit 22B to determine the start of a voice section from the sound data obtained during the third time period.

For that reason, in the transmission device 10B according to the third embodiment, a situation is prevented in which the start of a voice section is determined from the sound data of a sound emanating from the transmission device 10B (for example, a sound representing a question).

Thus, in the transmission device 10B according to the third embodiment, in addition to achieving the effect according to the first and second embodiments, the start of a voice section can be determined with accuracy.

### Fourth Embodiment

In a fourth embodiment, the explanation is given for a voice recognition system that includes a transmission device and a voice recognition device.

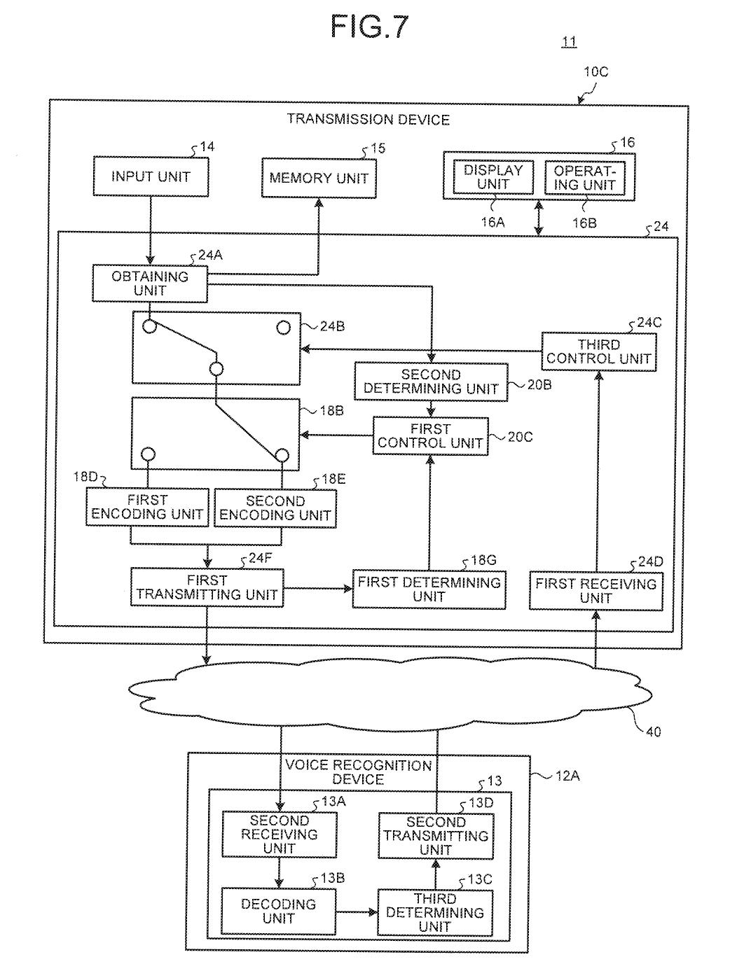

FIG. 7 is a block diagram illustrating an example of a voice recognition system 11 according to the fourth embodiment.

The voice recognition system 11 includes a transmission device 10C and a voice recognition device 12A. The transmission device 10C is connected to the voice recognition device 12A via the network 40. Herein, the network 40 is identical to the first embodiment.

The transmission device 10C sends encoded sound data to the voice recognition device 12A via the network 40.

The transmission device 10C is implemented in a handheld terminal, for example. The voice recognition device 12A is implemented in a server device, for example. Moreover, the voice recognition device 12A has superior computing performance as compared to the transmission device 10C and is capable of executing more advanced algorithms.

The transmission device 10C includes the input unit 14, a memory unit 15, the UI unit 16, and a control unit 24. Herein, the control unit 24 is connected with the input unit 14, the memory unit 15, and the UI unit 16 in a manner enabling communication of data and signals. Moreover, the input unit 14 and the UI unit 16 are identical to the first embodiment.

The memory unit 15 stores therein a variety of data. For example, the memory unit 15 is a hard disk drive (HDD). Meanwhile, the memory unit 15 can alternatively be included in the memory unit 15 and can be used as an internal memory (buffer).

In the fourth embodiment, the memory unit 15 stores therein sound data, which is output from the input unit 14 to the control unit 24, in an associated manner with timing information indicating the timing of input of that sound data. Herein, the timing of input of sound data represents the timing at which the sound of the concerned sound data is input to the input unit 14 (i.e., the timing at which the sound is converted into sound data by a microphone).

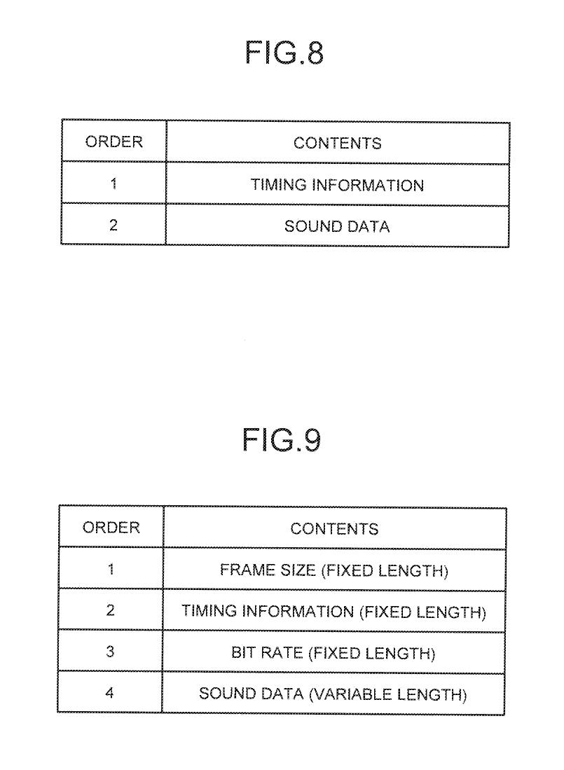

FIG. 8 is a diagram illustrating an exemplary data structure of the sound data stored in the memory unit 15. As illustrated in FIG. 8, the memory unit 15 stores therein timing information, which indicates the input timing, in an associated manner with sound data. That is, the sound data stored in the memory unit 15 is not encoded by the first encoding unit 18D or the second encoding unit 18E, and is obtained without modification from the input unit 14 (as raw data). The sounds input to the input unit 14 are sequentially written as pieces of sound data in the memory unit 15.

Returning to the explanation with reference to FIG. 7, the control unit 24 is a computer including a central processing unit (CPU), and controls the entire transmission device 10C. However, the control unit 24 is not limited to include a CPU, and alternatively can be configured with circuitry.

The control unit 24 includes an obtaining unit 24A, a second switching unit 24B, the first switching unit 18B, the second determining unit 20B, the first control unit 20C, the first encoding unit 18D, the second encoding unit 18E, a first transmitting unit 24F, the first determining unit 18G, a third control unit 24C, and a first receiving unit 24D. Some or all of the obtaining unit 24A, the second switching unit 24B, the first switching unit 18B, the second determining unit 20B, the first control unit 20C, the first encoding unit 18D, the second encoding unit 18E, the first transmitting unit 24F, the first determining unit 18G, the third control unit 24C, and the first receiving unit 24D can be implemented by making a processor such as a CPU to execute computer programs, that is, can be implemented using software; or can be implemented using hardware such as an integrated circuit (IC); or can be implemented using a combination of software and hardware.

Herein, the first switching unit 18B, the first encoding unit 18D, the second encoding unit 18E, and the first determining unit 18G are identical to the first embodiment. Moreover, the second determining unit 20B and the first control unit 20C are identical to the second embodiment.

The obtaining unit 24A obtains sound data from the input unit 14. That is, when a sound is input thereto, the input unit 14 sequentially outputs sound data of the sound to the obtaining unit 24A. Thus, the obtaining unit 24A obtains the sound data from the input unit 14. Then, the obtaining unit 24A sequentially stores the obtained sound data in the memory unit 15. Herein, the obtaining unit 24A sequentially stores, in the memory unit 15, the sound data output from the input unit 14 to the obtaining unit 24A and timing information, which indicates the timing of input of the concerned sound data, in an associated manner.

The second switching unit 24B switches the output source, from which sound data is to be output to the first encoding unit 18D and the second encoding unit 18E, between the obtaining unit 24A and the memory unit 15. Herein, the second switching unit 24B is controlled by the third control unit 24C.

The first receiving unit 24D receives the start timing of a voice section from the voice recognition device 12A. When the start timing is received, the third control unit 24C switches the sound data to be output to the first encoding unit 18D or the second encoding unit 18E, from the sound data obtained by the obtaining unit 24A from the input unit 14 to the sound data that is stored in the memory unit 15 and that is associated with the timing information subsequent to the received start timing.

Hence, until the start timing of a voice section is received from the voice recognition device 12A, the first encoding unit 18D and the second encoding unit 18E encode the sound data obtained by the obtaining unit 24A from the input unit 14. After the start timing of a voice section is received from the voice recognition device 12A, the first encoding unit 18D and the second encoding unit 18E encode, from among the sound data stored in the memory unit 15, the sound data associated with the timing information subsequent to the received start timing.

Meanwhile, as explained in the second embodiment, when the bandwidth of the network 40 is determined to have exceeded the first bit rate or when a voice section is determined to have started, the first encoding unit 18D encodes the sound data. Moreover, after the activation, during the period of time in which the bandwidth of the network 40 does not exceed the first bit rate and the start of a voice section is not determined, the second encoding unit 18E encodes the sound data.

The first transmitting unit 24F transmits the encoded sound data, which is obtained by means of encoding by the first encoding unit 18D or the second encoding unit 18E, to the voice recognition device 12A via the network 40. In the fourth embodiment, the first transmitting unit 24F transmits the encoded sound data along with the timing information corresponding to the sound data.

FIG. 9 is a diagram illustrating an example of a frame. For example, as illustrated in FIG. 9, a frame transmitted by the first transmitting unit 24F includes the frame size, the timing information, the bit rate, and the sound data. The frame size, the timing information, and the bit rate have a fixed length; while the sound data has a variable length. The bit rate specified in a frame represents the bit rate of encoded sound data.

The voice recognition device 12A receives encoded sound data and performs voice recognition.

The voice recognition device 12A includes a control unit 13, which is a computer including a central processing unit (CPU) and which controls the entire voice recognition device 12A. However, the control unit 13 is not limited to include a CPU, and can alternatively be configured with circuitry.

The control unit 13 includes a second receiving unit 13A, a decoding unit 13B, a third determining unit 13C, and a second transmitting unit 13D. Some or all of the second receiving unit 13A, the decoding unit 13B, the third determining unit 13C, and the second transmitting unit 13D can be implemented by making a processor such as a CPU to execute computer programs, that is, can be implemented using software; or can be implemented using hardware such as an integrated circuit (IC); or can be implemented using a combination of software and hardware.

The second receiving unit 13A receives encoded sound data from the transmission device 10C via the network 40. In the fourth embodiment, the second receiving unit 13A receives encoded sound data and timing information.

The decoding unit 13B decodes the encoded sound data. As a result, the decoding unit 13B obtains decoded sound data along with the timing information corresponding to the sound data.

Based on the sound data decoded by the decoding unit 13B, the third determining unit 13C determines the start of a voice section. In an identical manner to the second determining unit 20B, the third determining unit 13C determines the start of a voice section from the sound data.

However, as compared to the second determining unit 20B of the transmission device 10C, the third determining unit 13C of the voice recognition device 12A is capable of performing high-accuracy determination of the start timing of a voice section, which requires a higher computing performance. Thus, as compared to the second determining unit 20B, the third determining unit 13C determines the start of a voice section with a higher degree of accuracy.

Hence, even if sound data encoded at the second bit rate is received, the third determining unit 13C can determine the start of a voice section with the accuracy substantially identical to the accuracy of determination regarding the sound data encoded at the first bit rate which is the higher bit rate.

The second transmitting unit 13D transmits, to the transmission device 10C, the start timing, at which a voice section is started, determined by the third determining unit 13C.

In an identical manner to the second embodiment, in the transmission device 100, after the transmission program is run in the transmission device 100, if the bandwidth of the network 40 does not exceed the first bit rate and if the start of a voice section is not determined, the sound data encoded by the first encoding unit 18D is transmitted to the voice recognition device 12A. When the first receiving unit 24D of the transmission device 100 according to the fourth embodiment receives the start timing from the voice recognition device 12A that is capable of determining the start of a voice section with more accuracy, the third control unit 24C switches the sound data to be output to the first encoding unit 18D or the second encoding unit 18E to the sound data that is stored in the memory unit 15 and that is associated with the timing information subsequent to the received start timing.

For that reason, at least some portion of the voice data transmitted by the first transmitting unit 24F to the voice recognition device 12A gets retransmitted to the voice recognition device 12A; and the sound data that is read from the memory unit 15 and that has been encoded is transmitted to the voice recognition device 12A.

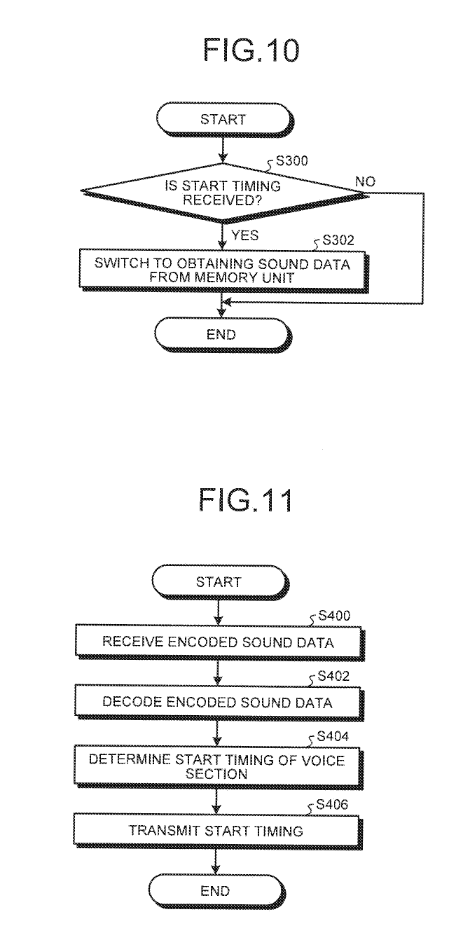

Given below is the explanation of a sequence of processes during the transmission process performed by the transmission device 100. In the transmission device 100, the transmission process is identical to the transmission process performed in the transmission device 10A according to the second embodiment (see FIG. 5). Besides, in the transmission device 100 according to the fourth embodiment, an interrupt process illustrated in FIG. 10 is included in the flowchart of the transmission process illustrated in FIG. 5.

FIG. 10 is a flowchart for explaining a sequence of processes during an interrupt process performed by the transmission device 10C.

The first receiving unit 24D determines whether the start timing of a voice section is received from the voice recognition device 12A (Step S300). If the start timing of a voice section is not received (No at Step S300), the present routine is ended. When the start timing of a voice section is received (Yes at Step S300), the system control proceeds to Step S302.

At Step S302, the third control unit 24C switches the sound data to be output to the first encoding unit 18D or the second encoding unit 18E from the sound data obtained by the obtaining unit 24A from the input unit 14 to the sound data that is stored in the memory unit 15 and that is associated with the timing information subsequent to the received start timing (Step S302). Then, the present routine is ended.

Given below is the sequence of processes during a voice recognition process performed in the voice recognition device 12A. FIG. 11 is a flowchart for explaining a sequence of processes during a voice recognition process performed in the voice recognition device 12A.

Firstly, the second receiving unit 13A receives encoded sound data and timing information from the transmission device 10C (Step S400).

Then, the decoding unit 13B decodes the encoded sound data that is received at Step S400 (Step S402). Subsequently, the third determining unit 13C determines the start of a voice section based on the decoded sound data obtained at Step S402 (Step S404). Then, the second transmitting unit 13D transmits the start timing of a voice section as determined at Step S404 to the transmission device 100 (Step S406). Then, the present routine is ended.

As explained above, in the fourth embodiment, the voice recognition device 12A includes the third determining unit 13C, which determines the start of a voice section with more accuracy than the second determining unit. Moreover, when the first receiving unit 24D of the transmission device 10C according to the fourth embodiment receives the start timing from the voice recognition device 12A that is capable of determining the start of a voice section with more accuracy, the third control unit 24C switches the sound data to be output to the first encoding unit 18D or the second encoding unit 18E to the sound data that is stored in the memory unit 15 and that is associated with the timing information subsequent to the received start timing.

In the transmission device 10C according to the fourth embodiment, in an identical manner to the second embodiment, after the transmission program is run by the transmission device 10C, if the bandwidth of the network 40 does not exceed the first bit rate and if the start of a voice section is not determined, the sound data encoded by the first encoding unit 18D is transmitted to the voice recognition device 12A. When the first determining unit 18G determines that the bandwidth of the network 40 has exceeded the first bit rate or when the second determining unit 20B determines the start of a voice section, the output destination of the sound data is switched from the second encoding unit 18E to the first encoding unit 18D.

For that reason, at least some portion of the sound data, which is transmitted by the first transmitting unit 24F to the voice recognition device 12A and which is encoded by the second encoding unit 18E capable of performing encoding at the second bit rate representing the lower bit rate, is read from the memory unit 15; encoded by the first encoding unit 18D; and retransmitted to the voice recognition device 12A.

In this way, in the voice recognition system 11 according to the fourth embodiment, the sound data encoded by the second encoding unit 18E is utilized in an effective manner; determination of a voice section is done by the third determining unit 13C capable of determining the start of a voice section in an effective manner; and the determination is used in controlling retransmission of sound data.

Hence, in the voice recognition system 11 according to the fourth embodiment, in addition to achieving the effect achieved in the embodiments described earlier, the voice of a user can be recognized with accuracy thereby enabling prevention of false recognition of voices.

### Fifth Embodiment

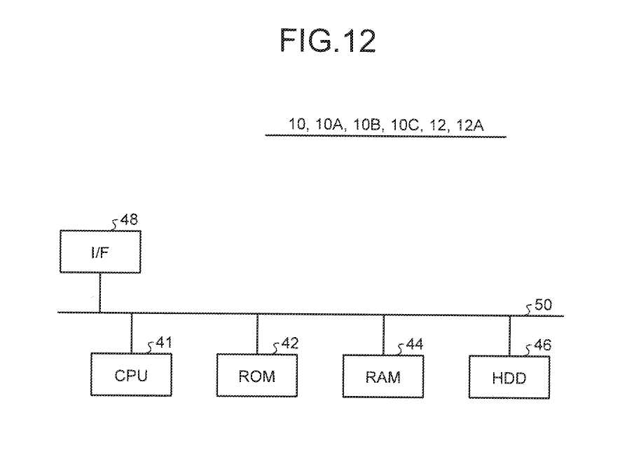

Given below is the explanation of a hardware configuration of the transmission devices 10, 10A, 10B, and 10C and the voice recognition devices 12 and 12A according to the embodiments described above. FIG. 12 is block diagram illustrating an exemplary hardware configuration of the transmission devices 10, 10A, 10B, and 10C and the voice recognition devices 12 and 12A according to the embodiments described above.

Each of the transmission devices 10, 10A, 10B, and 10C and the voice recognition devices 12 and 12A according to the embodiments described above has a hardware configuration of a general-purpose computer in which an interface (I/F) 48, a central processing unit (CPU) 41, a read only memory (ROM) 42, a random access memory (RAM) 44, and a hard disk drive (HDD) 46 are connected to each other by a bus 50.

The CPU 41 is a processor that controls the overall operations of each of the transmission devices 10, 10A, 10B, and 10C and the voice recognition devices 12 and 12A according to the embodiments described above. The RAM 44 stores therein the data required in various operations performed in the CPU 41. The ROM 42 stores therein computer programs executed by the CPU 41 to perform various operations. The HDD 46 stores therein data that is to be stored in the memory unit 15. The I/F 48 is an interface for establishing connection with an external device or an external terminal via a communication line and communicating data with the external device or the external terminal.

Meanwhile, a computer program to be executed for performing a transmission process in the transmission devices 10, 10A, 10B, and 10C according to the embodiments described above and a computer program to be executed for performing a voice recognition process in the voice recognition devices 12 and 12A according to the embodiments described above are stored in advance in the ROM 42.

Alternatively, the computer program to be executed for performing a transmission process in the transmission devices 10, 10A, 10B, and 10C according to the embodiments described above and the computer program to be executed for performing a voice recognition process in the voice recognition devices 12 and 12A according to the embodiments described above can be recorded as installable files or executable files in a computer-readable recording medium such as a compact disk read only memory (CD-ROM), a flexible disk (FD), a compact disk recordable (CD-R), or a digital versatile disk (DVD).

Still alternatively, the computer program to be executed for performing a transmission process in the transmission devices 10, 10A, 10B, and 10C according to the embodiments described above and the computer program to be executed for performing a voice recognition process in the voice recognition devices 12 and 12A according to the embodiments described above can be saved in a downloadable manner on a computer connected to a network such as the Internet. Still alternatively, the computer program to be executed for performing a transmission process in the transmission devices 10, 10A, 10B, and 10C according to the embodiments described above and the computer program to be executed for performing a voice recognition process in the voice recognition devices 12 and 12A according to the embodiments described above can be distributed over a network such as the Internet.

Herein, the computer program to be executed for performing a transmission process in the transmission devices 10, 10A, 10B, and 10C according to the embodiments described above as well as the computer program to be executed for performing a voice recognition process in the voice recognition devices 12 and 12A according to the embodiments described above contains modules for the constituent elements described above. As the actual hardware, the CPU 41 reads the computer program for performing one of the two operations from a memory medium such as the ROM 42 and runs it so that the computer program is loaded in a main memory device. As a result, the constituent elements are generated in the main memory device.

Meanwhile, regarding the transmission devices 10, 10A, 10B, and 10C and the voice recognition devices 12 and 12A according to the described above, the functional constituent elements thereof need not be implemented using computer programs (software) only. Some or all of the functional constituent elements can be implemented using dedicated hardware such as an application specific integrated circuit (ASIC) or a field-programmable gate array (FPGA).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmission device comprising:
an obtaining unit configured to obtain sound data;
a first encoding unit configured to encode the sound data at a first bit rate;
a second encoding unit configured to encode the sound data at a second bit rate which is lower than the first bit rate;
a first determining unit configured to determine whether a bandwidth of a network, which is subjected to congestion control, has exceeded the first bit rate;
a first control unit configured, when the bandwidth of the network is determined to have exceeded the first bit rate, to switch an output destination of obtained sound data from the second encoding unit to the first encoding unit; and
a first transmitting unit configured to transmit the obtained sound data, that is encoded by the first encoding unit or the second encoding unit, to a voice recognition device via the network.

2. The device according to claim 1, wherein, after the output destination of the obtained sound data is switched from the second encoding unit to the first encoding unit, if the bandwidth of the network is determined to be equal to or lower than the first bit rate, the first control unit keeps the output destination switched to the first encoding unit.

3. The device according to claim 1, wherein
regarding the sound data obtained during a first time period starting from activation of the transmission device up to determination that the bandwidth of the network has exceeded the first bit rate, the first control unit keeps the output destination of the sound data switched to the second encoding unit, and
regarding the sound data obtained during a second time period starting after it is determined that the bandwidth of the network has exceeded the first bit rate, the first control unit sets the output destination to the first encoding unit.

4. The device according to claim 1, further comprising a second determining unit configured to determine start of a voice section, wherein
when the bandwidth of the network is determined to have exceeded the first bit rate or when start of the voice section is determined, the first control unit switches the output destination of the obtained sound data from the second encoding unit to the first encoding unit.

5. The device according to claim 4, further comprising a second control unit configured to control the second determining unit to estimate a period of time in which a voice is input and to determine start of the voice section from the sound data obtained in the period of time.

6. A voice recognition system comprising
a transmission device; and
a voice recognition device that is connected to the transmission device via a network subjected to congestion control, wherein
the transmission device includes
an obtaining unit configured to obtain sound data from an input unit which receives input of sound,
a memory unit configured to store, in an associated manner, the sound data and timing information indicating input timing of the sound data,
a second determining unit configured to determine a start of a voice section from the obtained sound data,
a first encoding unit configured to encode the sound data at a first bit rate,
a second encoding unit configured to encode the sound data at a second bit rate which is lower than the first bit rate,
a first determining unit configured to determine whether a bandwidth of the network has exceeded the first bit rate,
a first control unit configured, when the bandwidth of the network is determined to have exceeded the first bit rate or when the start of the voice section is determined, to switch an output destination of the obtained sound data from the second encoding unit to the first encoding unit,
a first transmitting unit configured to transmit the obtained sound data, that is encoded by the first encoding unit or the second encoding unit, to the voice recognition device via the network,
a first receiving unit configured to receive a start timing of a voice section from the voice recognition device, and
a third control unit configured, when the start timing is received, to switch the sound data to be output to the first encoding unit or the second encoding unit from the sound data obtained by the obtaining unit from the input unit to the sound data that is stored in the memory unit and that is associated with the timing information subsequent to the received start timing, and
the voice recognition device includes
a second receiving unit configured to receive the encoded sound data from the transmission device,
a decoding unit configured to decode the encoded sound data,
a third determining unit configured, based on the decoded sound data, to determine a start of a voice section with more accuracy than the second determining unit, and
a second transmitting unit configured to transmit a start timing, at which the voice section is determined to have started, to the transmission device.

7. A transmission method comprising:
obtaining sound data;
encoding the sound data at a first bit rate;
encoding the sound data at a second bit rate which is lower than the first bit rate;
determining whether a bandwidth of a network, which is subjected to congestion control, has exceeded the first bit rate;
switching, when the bandwidth of the network is determined to have exceeded the first bit rate, an output destination of the obtained sound data from the second encoding unit to the first encoding unit; and
transmitting the obtained sound data, that is encoded at the first bit rate or the second bit rate, to a voice recognition device via the network.

8. A computer program product comprising a computer readable medium including programmed instructions, wherein the programmed instructions, when executed by a computer, cause the computer to perform:
obtaining sound data;
encoding the sound data at a first bit rate;
encoding the sound data at a second bit rate which is lower than the first bit rate;
determining whether a bandwidth of a network, which is subjected to congestion control, has exceeded the first bit rate;
switching, when the bandwidth of the network is determined to have exceeded the first bit rate, an output destination of the obtained sound data from the second encoding unit to the first encoding unit; and
transmitting the obtained sound data, that is encoded at the first bit rate or the second bit rate, to a voice recognition device via the network.
